(19) United States
(12) Patent Application Publication
(10) Pub. No.: US 2007/0046616 A1
(43) Pub. Date: Mar. 1, 2007

(54) Liquid crystal display apparatus and backlight module thereof

(75) Inventor: Feng-Li Lin, Taipei County (TW)

Correspondence Address: BIRCH STEWART KOLASCH & BIRCH, PO BOX 747, FALLS CHURCH, VA, 22040-0747, US

(73) Assignee: GIGNO TECHNOLOGY CO., LTD.

(21) Appl. No.: 11/484,711

(22) Filed: Jul. 12, 2006

(30) Foreign Application Priority Data
Aug. 29, 2005 (TW) 094129562

(51) Int. Cl. G09G 3/36

(52) U.S. Cl. 345/102

(57) ABSTRACT

A backlight module at least includes a light-emitting unit, a driving circuit board, and a casing. The light-emitting unit at least has an electrode pin. The driving circuit board at least generates a power signal for driving the light-emitting unit. The electrode pin of the light-emitting unit is directly connected to the driving circuit board. The casing has a reflection surface and a lateral surface, which is approximately perpendicular to the reflection surface. In this case, the driving circuit board is disposed at the lateral surface of the casing, and the light-emitting unit is disposed above and approximately parallel to the reflection surface.

### BACKGROUND OF THE INVENTION

1. Field of Invention

The invention relates to a flat display apparatus and the backlight module thereof. In particular, the invention relates to a liquid crystal display apparatus and the backlight module thereof.

2. Related Art

In general, the liquid-crystal display apparatus mainly includes a liquid-crystal display unit and a backlight module. At present, two types of the backlight module are usually adopted: the direct-type backlight module and side-edge backlight module.

Both the aforementioned backlight modules need at least one driving circuit board to drive the light-emitting units of the backlight modules. At present, the manufacturer usually utilizes cold cathode fluorescent lamps (CCFL) as the light-emitting units, and uses the driving circuit board to provide a driving signal with a high voltage for driving the light-emitting units.

As shown in FIG. 1, in order to facilitate connecting and assembling the light-emitting unit 11 (CCFL) and the driving circuit board 13, the manufacturer may install a connecting wire 12, which is high voltage durable and includes a connecting terminal 121, to electrically connect the electrode terminals 111 and 112 of the light-emitting unit 11. The connecting terminal 121 then connects to a connecting terminal 131 of the driving circuit board 13. In such a case, the high-voltage driving signal outputted by the driving circuit board 13 can be transmitted to the light-emitting unit 11 for driving it through the connecting terminal 131, the connecting terminal 121 and the connecting wire 12.

In the above-mentioned backlight module, the driving signal provided by the driving circuit board 13 is commonly at the kilovolt level. Therefore, if the connecting terminal 131 of the driving circuit board 13 and the connecting terminal 121 of the connecting wire 12 do not properly connect to each other or are in poor contact, the arcing phenomenon always occurs and may even cause disasters. Moreover, to connect the light-emitting unit 11 to the driving circuit board 13 with the connecting wire 12, labor work is inevitable. In other words, the manufacturing process cannot be automatic. Besides, the connecting wire 12 and the connecting terminals 121 and 131 must be high voltage durable, so that the material cost is higher. In addition, since the signal passing through the connecting wire 12 is a kilovolt-level high-voltage signal working at as high frequency as KHz, the current leakage phenomenon may occur along the connecting wire 12 due to the coupling effect from the space stray capacitance. As a result, the current for driving the light-emitting unit may not be easily controlled, and thus the power transmission efficiency is decreased. In the prior art, the above-mentioned driving circuit board 13 is usually installed on the rear board of the backlight module, so that the automatic assembling may not be carried out.

To solve the cost problem of high-voltage connection wires and high-voltage connection terminals, manufacturers have invented a backlight module 2 shown in FIG. 2. The electrode ends 211, 212 of the light-emitting unit 21 are connected to a circuit board 22 on the lateral surface of a reflection board 23. The circuit board 22 is disposed with a connection terminal 221 and several metal wires 222. The connection terminal 221 is coupled to a connection terminal 241 of a driving circuit board 24 via a connection terminal 251 of a connection wire 25. The high voltage provided by the driving circuit board 24 is transferred to the light-emitting unit 21 via the connection wire 25, the connection terminal 221 of the circuit board 22, and the metal wire 222.

Although the above-mentioned backlight module can use the circuit board 22 to achieve the effect of partially automatic assembly, it still requires the use of connection terminals that can withstand high voltages. The cost is partly reduced. However, the use of high-voltage connection wires and terminals cannot avoid sparking and electricity leakage. This renders the electric current for driving the light-emitting unit difficult to control. Therefore, the power conversion efficiency is reduced.

It is therefore an important subject of the invention to provide a liquid-crystal display apparatus and a backlight module thereof, which can enable automation for reducing the manufacturing cost and can prevent the arcing phenomenon and the current leakage phenomenon.

### SUMMARY OF THE INVENTION

In view of the foregoing, the invention is to provide a liquid-crystal display apparatus and a backlight module thereof, which can prevent the arcing phenomenon and the current leakage phenomenon and can enable the automation of the manufacturing process.

To achieve the above, a backlight module according to the invention includes at least a light-emitting unit, a driving circuit board, and a casing. The light-emitting unit at least has an electrode pin. The driving circuit board at least generates a power signal for driving the light-emitting unit. The electrode pin of the light-emitting unit is directly connected to the driving circuit board. The casing has a reflection surface and a lateral surface, which is approximately perpendicular to the reflection surface. In this case, the driving circuit board is disposed at the lateral surface of the casing, and the light-emitting unit is disposed above and approximately parallel to the reflection surface.

As mentioned above, the backlight module has a light-emitting unit, which is directly connected to the driving circuit board. In other words, the power signal provided by the power signal generating circuit is directly fed to the light-emitting unit. Therefore, it avoids sparking due to a bad connection between the connection wire and the connection terminal. Besides, the light-emitting unit is directly connected to the driving circuit board without the use of a connection wire. That is, the connection between the light-emitting unit and the driving circuit board can be established using automatic equipment instead of manually. Moreover, since the light-emitting unit and the driving circuit board are directly connected, there is no need to use connection wires and terminals that can withstand high voltages. In other words, a lot of cost on the high-voltage-withstanding connection wires and terminals can be saved. This also prevents the electricity leakage.

In addition, the invention also discloses a liquid crystal display (LCD) apparatus which has a backlight module with at least a light-emitting unit, a driving circuit board, and a casing. The light-emitting unit at least has an electrode pin. The driving circuit board at least generates a power signal for driving the light-emitting unit. The electrode pin of the light-emitting unit is directly connected to the driving circuit board. The casing has a reflection surface and a lateral approximately perpendicular to the reflection surface. The driving circuit board is disposed at the lateral surface of the casing. The light-emitting unit is disposed above and approximately parallel to the reflection surface.

As mentioned above, the backlight module of the LCD apparatus has a light-emitting unit directly connected to the driving circuit board. In other words, the power signal provided by the power signal generating circuit is directly fed to the light-emitting unit. Therefore, it avoids sparking due to a bad connection between the connection wire and the connection terminal. Besides, the light-emitting unit is directly connected to the driving circuit board without the use of a connection wire. That is, the connection between the light-emitting unit and the driving circuit board can be established using automatic equipment instead of manually. Moreover, since the light-emitting unit and the driving circuit board are directly connected, there is no need to use connection wires and terminals that can withstand high voltages. In other words, a lot of cost on the high-voltage-withstanding connection wires and terminals can be saved. This also prevents the electricity leakage.

### BRIEF DESCRIPTION OF THE DRAWINGS

The invention will become more fully understood from the detailed description given herein below illustration only, and thus is not limitative of the present invention, and wherein:

FIG. 1 is a schematic view showing the primary component of a conventional backlight module;

FIG. 2 is a schematic view showing the primary component of another conventional backlight module;

FIGS. 3A and 3B are schematic views showing the primary components of a backlight module according to a preferred embodiment of the invention;

FIG. 4 is a schematic view showing another component in the backlight module according to a preferred embodiment of the invention, wherein a driving circuit board is disposed on each side of the light-emitting unit;

FIG. 5 is a schematic view showing the circuit of the driving circuit board of the backlight module according to a preferred embodiment of the invention;

FIG. 6 is a schematic view showing primary components of the driving circuit board in FIG. 5;

FIG. 7 is a schematic view showing additional primary components of the driving circuit board in FIG. 5; and

FIG. 8 is a schematic view showing the primary components of the LCD apparatus according to a preferred embodiment of the invention.

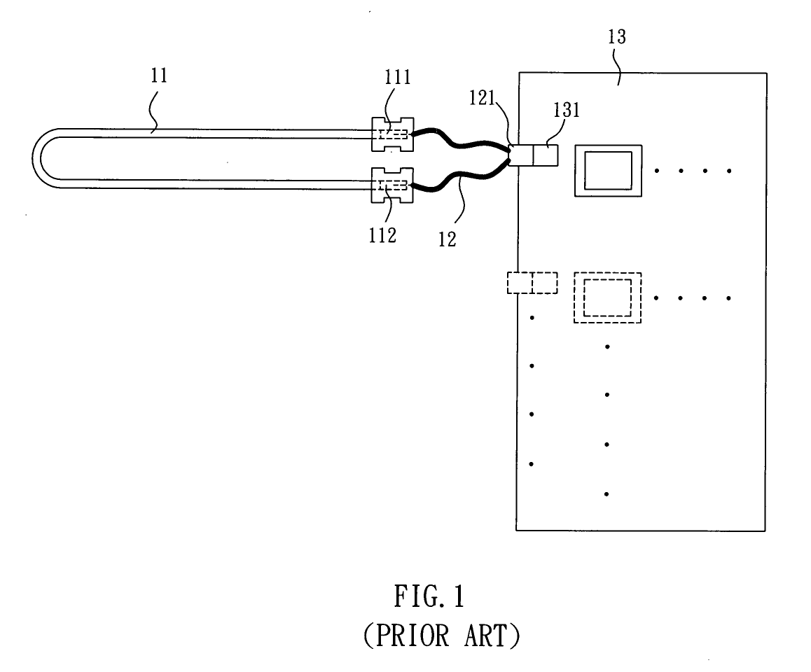

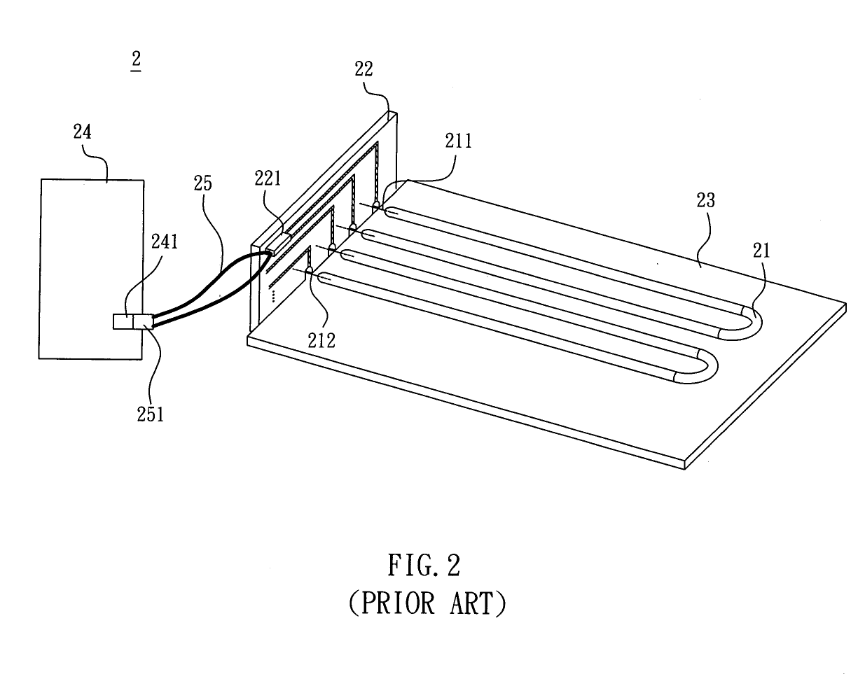

### DETAILED DESCRIPTION OF THE INVENTION

The present invention will be apparent from the following detailed description, which proceeds with reference to the accompanying drawings, wherein the same references relate to the same elements.

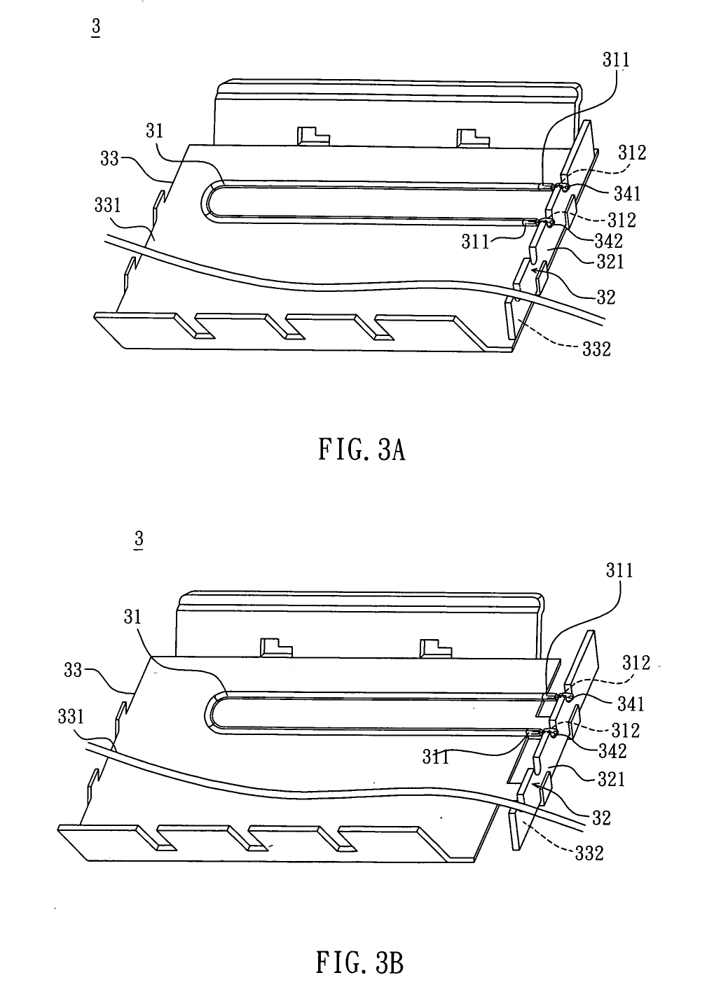

With reference to FIG. 3A, a preferred embodiment of the backlight module 3 include at least a light-emitting unit 31, a driving circuit board 32, and a casing 33.

The light-emitting unit 31 at least has an electrode 311 and an electrode pin 312. In this embodiment, the light-emitting unit 31 is a cold cathode fluorescent lamp (CCFL), which has two electrodes 311 and two electrode pins 312 connected to the electrodes. Besides, the light-emitting unit 31 can be either a hot cathode fluorescent lamp or a flat lamp.

The driving circuit board 32 at least generates a power signal for driving the light-emitting unit 31. The electrode pins 312 of the light-emitting unit 31 are directly connected to the driving circuit board 32. In this embodiment, each of the electrode pins 312 of the light-emitting unit 31 is soldered on the driving circuit board 32 to form a solder point 341, thereby electrically coupled to the driving circuit board 32, followed by the step of forming a protection layer 342 that can withstand high voltages. Of course, the electrode pins 312 of the light-emitting unit 31 can be electrically coupled to the driving circuit board 32 by clicking or other means.

The casing 33 has a reflection surface 331 and a lateral surface 332 approximately perpendicular to the reflection surface 331. The driving circuit board 32 is disposed at the lateral surface 332 of the casing 33. The light-emitting unit 31 is disposed above and approximately parallel to the reflection surface 331 of the casing 33. In this embodiment, the casing 33 is metal. The driving circuit board 32 has a loop surface 321, which is disposed at the lateral surface 332 and approximately perpendicular to the reflection surface 331 of the casing 33.

In this embodiment, the driving circuit board 32 is directly disposed outside the lateral surface 332 of the casing 33. As shown in FIG. 3B, the driving circuit board 32 is essentially disposed on the lateral surface 332 of the casing 33 using a fixture component 333.

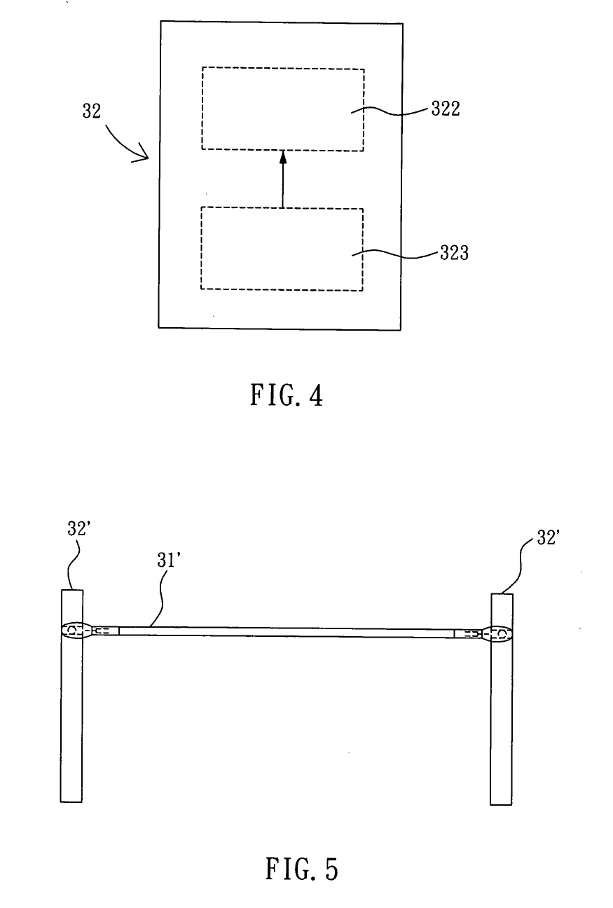

Moreover, as shown in FIG. 4, the driving circuit board 32 in this embodiment includes a power signal generating circuit 322 and a switching signal generating circuit 323. The power signal generating circuit 322 generates a power signal for driving the light-emitting unit 31. The switching signal generating circuit 323 generates at least one switching signal, so that the power signal generating circuit 322 generates the power signal according to the switching signal.

Besides, the light-emitting unit 31 is a U-shaped CCFL. When the light-emitting unit 31′ is a straight CCFL and driven on both sides, as shown in FIG. 5, a driving circuit board 32′ is installed on each side to drive the light-emitting unit 31′.

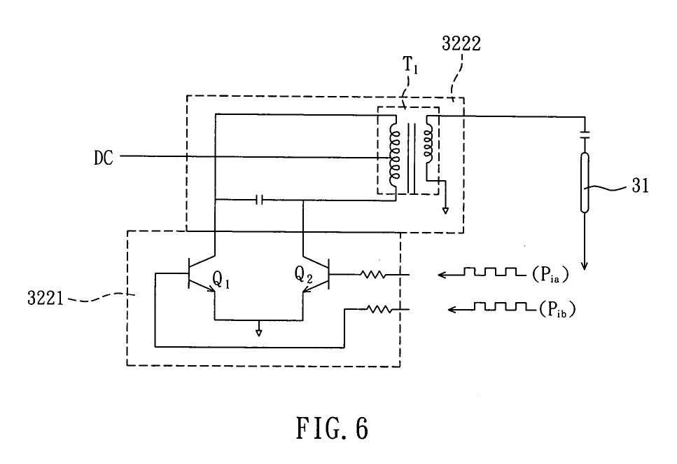

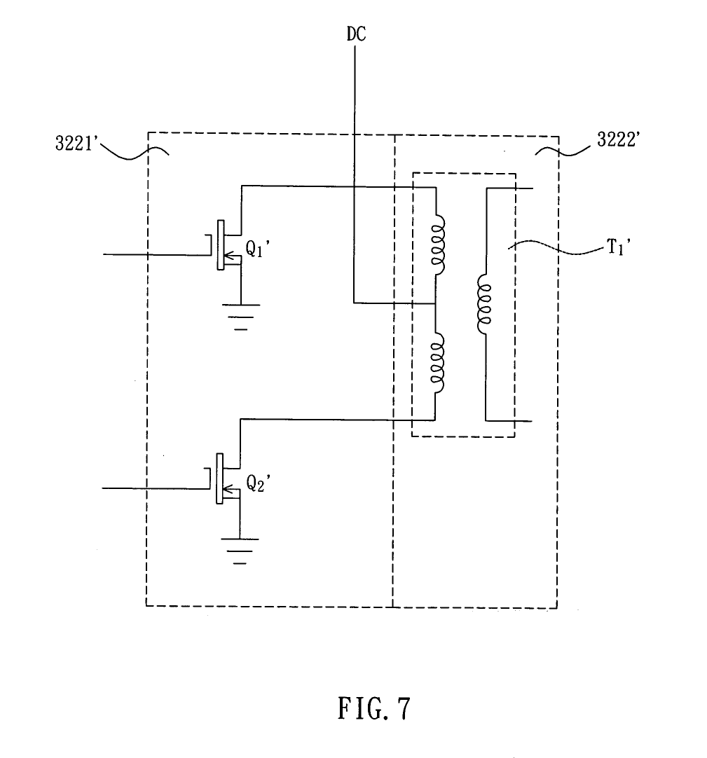

As shown in FIG. 6, the power signal generating circuit 322 includes a switching circuit 3221 and a voltage raising circuit 3222. The switching circuit 3221 is electrically coupled to the switching signal generating circuit 323, and switches on and off according to a set of switching signal (Pᵢₐ, P_{ib}) output by the switching signal generating circuit 323 (see FIG. 6). The voltage raising circuit 3222 is electrically coupled to the switching circuit 3221. It generates the power signal according to the power on and off action of the switching circuit 3221. FIG. 6 shows an explicit construction of the power signal generating circuit 322. As shown in the drawing, the voltage raising circuit 3222 of the power signal generating circuit 322 includes a transformer T₁ and a capacitor C₁. The switching circuit 3221 includes two transistors Q₁, Q₂, each of which is electrically coupled to one side of the capacitor C₁. The transistors Q₁, Q₂ perform the power on and off action according to the switching signal. As shown in FIG. 7, the power signal generating circuit 322′ may have another construction. That is, the voltage raising circuit 3222′ includes a transformer T₁′, and the switching circuit 3221′ includes two transistors Q₁′, Q₂′. The transistors Q₁′, Q₂′ are respectively coupled to a secondary coil of the transformer T₁′. The transistors Q₁′, Q₂′ perform the power on and off action according to the switching signal.

In summary, the backlight module has a driving circuit board disposed on the lateral surface of the casing. The light-emitting unit is directly connected to the driving circuit board. In other words, the power signal provided by the power signal generating circuit is directly fed to the light-emitting unit. Therefore, it avoids sparking due to a bad connection between the connection wire and the connection terminal. Besides, the light-emitting unit is directly connected to the driving circuit board without the use of a connection wire. That is, the connection between the light-emitting unit and the driving circuit board can be established using automatic equipment instead of manually. Moreover, since the light-emitting unit and the driving circuit board are directly connected, there is no need to use connection wires and terminals that can withstand high voltages. In other words, a lot of cost on the high-voltage-withstanding connection wires and terminals can be saved. This also prevents the electricity leakage.

The above paragraphs give a detailed description of the backlight module according to a preferred embodiment of the invention. The following paragraphs describe the LCD apparatus of the invention.

The LCD apparatus according to a preferred embodiment of the invention includes a LCD unit and a backlight module. The backlight module here is the same as in the previous embodiment. That is, the backlight module 3 at least includes a light-emitting unit 31, a driving circuit board 32, and a casing 33 (see again FIG. 3A).

The light-emitting unit 31 at least has an electrode 311 and an electrode pin 312. The driving circuit board 32 at least generates a power signal for driving the light-emitting unit 31. The electrode pin 312 of the light-emitting unit 31 is directly connected to the driving circuit board 32. The casing 33 has a reflection surface 331 and a lateral surface 332 approximately perpendicular to the reflection surface 331. The driving circuit board 32 is disposed at the lateral surface 332 of the casing 33. The light-emitting unit 31 is disposed above and approximately parallel to the reflection surface 331 of the casing 33.

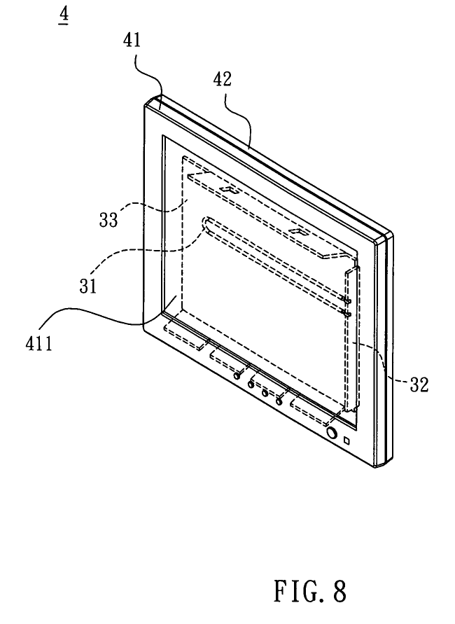

As shown in FIG. 8, the LCD apparatus 4 according to the invention further includes outer casings 41, 42. The backlight module 3 is disposed inside the outer casings 41, 42. The outer casing 41 has a display surface 411 approximately parallel to the reflection surface 331 of the backlight module 3. In this case, the driving circuit board 32 is disposed approximately perpendicular to the display surface 411 of the outer casing 41.

More explicitly, the driving circuit board 32 of the backlight module 3 of the disclosed LCD apparatus is disposed approximately perpendicular to a lateral surface of the casing 33. Using either configuration in FIGS. 3A and 3B, the driving circuit board 32 is disposed on the lateral side formed by the outer casings 41, 42.

In summary, the backlight module of the disclosed LCD apparatus has a driving circuit board disposed on the lateral surface of the casing. The light-emitting unit is directly connected to the driving circuit board. In other words, the power signal provided by the power signal generating circuit is directly fed to the light-emitting unit. Therefore, it avoids sparking due to a bad connection between the connection wire and the connection terminal. Besides, the light-emitting unit is directly connected to the driving circuit board without the use of a connection wire. That is, the connection between the light-emitting unit and the driving circuit board can be established using automatic equipment instead of manually. Moreover, since the light-emitting unit and the driving circuit board are directly connected, there is no need to use connection wires and terminals that can withstand high voltages. In other words, a lot of cost on the high-voltage-withstanding connection wires and terminals can be saved. This also prevents the electricity leakage.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A backlight module, which at least comprises a light-emitting unit, a driving circuit board, and a casing, wherein the light-emitting unit at least has an electrode pin, the driving circuit board at least generates a power signal for driving the light-emitting unit, the electrode pin of the light-emitting unit is directly connected to the driving circuit board, the casing has a reflection surface and a lateral surface approximately perpendicular to the reflection surface, the light-emitting unit is disposed approximately parallel to the reflection surface, and the backlight module is characterized in that:
the driving circuit board is disposed at the lateral surface of the casing.

2. The backlight module of claim 1, wherein the driving circuit board further comprises:
a power signal generating circuit, which generates the power signal for driving the light-emitting unit; and
a switching signal generating circuit, which generates at least a switching signal, wherein the power signal generating circuit generates the power signal according to the switching signal.

3. The backlight module of claim 2, wherein the power signal generating circuit further comprises:
a switching circuit, which is electrically coupled to the switching signal generating circuit and performs power on and off according to the switching signal output by the switching signal generating circuit; and
a voltage raising circuit, which is electrically coupled to the switching circuit and generates the power signal according to the on and off of the switching circuit.

4. The backlight module of claim 1, wherein the casing is a metal casing.

5. The backlight module of claim 4, wherein the driving circuit board has a circuit surface, and the circuit surface is approximately perpendicular to the reflection surface of the casing.

6. The backlight module of claim 4, wherein the driving circuit board has a circuit surface, and the circuit surface is approximately parallel to the reflection surface of the casing.

7. The backlight module of claim 1, wherein the light-emitting unit is a cold cathode fluorescent lamp (CCFL).

8. The backlight module of claim 1, wherein the light-emitting unit is a flat lamp.

9. The backlight module of claim 1, wherein the electrode pin of the light-emitting unit is directly connected to the driving circuit board by soldering.

10. A liquid crystal display (LCD) apparatus having a backlight module, wherein the backlight module at least comprises a light-emitting unit, a driving circuit board, and a casing, the light-emitting unit at least has an electrode pin, the driving circuit board at least generates a power signal for driving the light-emitting unit, the electrode pin of the light-emitting unit is directly connected to the driving circuit board, the casing has a reflection surface and a lateral surface approximately perpendicular to the reflection surface, the light-emitting unit is disposed approximately parallel to the reflection surface, and the LCD apparatus is characterized in that:
the driving circuit board is disposed at the lateral surface of the casing.

11. The LCD apparatus of claim 10, wherein the driving circuit board further comprises:
a power signal generating circuit, which generates the power signal for driving the light-emitting unit; and
a switching signal generating circuit, which generates at least a switching signal, wherein the power signal generating circuit generates the power signal according to the switching signal.

12. The LCD apparatus of claim 11, wherein the power signal generating circuit further comprises:
a switching circuit, which is electrically coupled to the switching signal generating circuit and performs power on and off according to the switching signal output by the switching signal generating circuit; and
a voltage raising circuit, which is electrically coupled to the switching circuit and generates the power signal according to the on and off of the switching circuit.

13. The LCD apparatus of claim 10, wherein the casing is a metal casing.

14. The LCD apparatus of claim 13, wherein the driving circuit board has a circuit surface, and the circuit surface is approximately perpendicular to the reflection surface of the casing.

15. The LCD apparatus of claim 13, wherein the driving circuit board has a circuit surface, and the circuit surface is approximately parallel to the reflection surface of the casing.

16. The LCD apparatus of claim 10, wherein the light-emitting unit is a cold cathode fluorescent lamp (CCFL).

17. The LCD apparatus of claim 10, wherein the light-emitting unit is a flat lamp.

18. The LCD apparatus of claim 10, wherein the electrode pin of the light-emitting unit is directly connected to the driving circuit board by soldering.

19. The LCD apparatus of claim 10 further comprising:
an outer casing, which has a display surface approximately parallel to the reflection surface of the casing.

20. The LCD apparatus of claim 19, wherein the driving circuit board is approximately perpendicular to the display surface.
